(19) United States
(12) Patent Application Publication
(10) Pub. No.: US 2023/0368100 A1
(43) Pub. Date: Nov. 16, 2023

(54) PROJECT TASK ASSIGNMENT METHOD

(71) Applicant: Gwo-Cheng Chao, Taipei City (TW)

(72) Inventor: Gwo-Cheng Chao, Taipei City (TW)

(21) Appl. No.: 18/195,482

(22) Filed: May 10, 2023

(30) Foreign Application Priority Data
May 12, 2022 (TW) 111117868

(51) Int. Cl. G06Q 10/0631; G06F 16/21

(52) U.S. Cl. CPC G06Q 10/06316; G06F 16/211

(57) ABSTRACT

A project task assignment method executed by a system communicating with a demand terminal and execution terminals. The system includes a storage device and a processor. The processor builds a task assignment database and an execution terminal database. When a project dispatching signal is received from the demand terminal, the processor acquires an assigned project type and project detail data, determines an assigned task assignment sequence, and generates matching scores. The processor acquires operation terminals, transmits one project starting signal to one of the operation terminals, and selectively stores the assigned task assignment sequence into the task assignment database as one of the candidate task assignment sequences. The processor generates one base score associated with the assigned task assignment sequence, computes a representative score of one of the candidate task assignment sequences corresponding to the assigned task assignment sequence, and stores the representative score into the task assignment database.

### CROSS-REFERENCE TO RELATED APPLICATIONS

This application claims the priority benefit of TW application serial No. 111117868, filed on May 12, 2022. The entirety of the above-mentioned patent applications is hereby incorporated by reference herein and made a part of specification.

### BACKGROUND OF THE INVENTION

### 1. Field of the Invention

The present invention relates to a project task assignment method, and more particularly to a project task assignment method which can optimize a result of the project.

### 2. Description of the Related Art

No matter for outsourcing or internal enterprise, when faced with a project that includes multiple professional types, it is usually necessary to determine an appropriate professional allocation method and execution process. Namely, the project can only be completed through a collaboration of various talents with different professional skills.

In particular, with a correct method of professional allocation and execution process, not only a success rate of the project can be improved, but also an overall execution efficiency can be improved.

As the French physicist Langevin said, when summarizing experiences and lessons of reading: “The appropriateness of the method often dominates the entire reading process, it can entrust you to the other side of success, and it can also pull you into the valley of failure”.

In the case of using the correct method of the professional allocation and the execution process, if suitable talents with different professional skills cooperate in the project, it will also have a positive effect on improving the quality of the project results.

However, a decision for the correct method of the professional allocation and the execution process usually depends on experience and cognition of a commissioned manufacturer or a supervisor in the enterprise who intends to outsource the project. Unless they have sufficient experience in handling the content of the project to be assigned, it is obviously difficult to plan the method of the professional allocation and the execution process for this project.

In particular, the manufacturers who need to seek assistance from outsourced personnel may only have a preliminary or even vague concept of this project, and have no idea how to complete this project in practice.

Even though it may be possible to initially know how to professionally allocate similar projects through data search, it is still impossible to improve the execution efficiency of such projects at the level of professional execution process.

In addition, most of the existing talent matchma king mechanisms manually review professional self-assessment sheets and experiences of potential talents who may undertake projects by the commissioning manufacturers or business executives.

Such information is not only too divergent, but it is also likely to produce different selection results due to the subjective judgment of the reviewers, and it is also impossible to easily know the effectiveness of each person's cooperation with other people from the above information.

This kind of problem not only easily occurs in the situation where the commissioned manufacturer needs to seek interaction and cooperation of multiple outsourced personnel, but also may occur in the situation where the company executives cannot fully grasp the status of the new recruits under their management.

In general, for the commissioned manufacturers or business executives who need to allocate projects, there is still a lack of a system or method that can find a suitable method of the professional allocation and the execution process that are suitable for each project, and it is impossible to continue to search for suitable ones. Therefore, it is not easy to ensure the quality of project execution.

### SUMMARY OF THE INVENTION

An objective of the present invention is to provide a project task assignment method. The project task assignment method allows multiple appropriate execution terminals to execute a project assigned by at least one demand terminal based on a better task assignment sequence through a consideration and scoring mechanism for a professional assignment method and execution process of a project, thereby improving an accomplished quality of the project.

To achieve the foregoing objective, the project task assignment method is executed by a project task assignment system. The project task assignment system includes a storage device and a processor.

The processor connects to the storage device, and communicates with the at least one demand terminal and the multiple execution terminals.

In one embodiment, the project task assignment method includes:
building a task assignment database and an execution terminal database in the storage device by the processor; wherein the task assignment database stores multiple candidate project types, and the execution terminal database stores multiple feedback data associated with multiple execution terminals;
receiving a project dispatching signal from the demand terminal, and acquiring an assigned project type and project detail data according to the project dispatching signal by the processor; wherein the assigned project type is one of the candidate project types;
determining an assigned task assignment sequence according to the project dispatching signal, and generating multiple matching scores corresponding to at least one part of the execution terminals by the processor; wherein one of the matching scores represents a matching degree between first data and second data; wherein the first data comprises the feedback data of one of the execution terminals, and the second data comprises the assigned project type and the project detail data;
acquiring multiple operation terminals at least based on the matching scores by the processor; wherein the operation terminals are one part of the execution terminals corresponding to the matching scores;
transmitting at least one project starting signal to at least one of the operation terminals according to the assigned task assignment sequence by the processor; wherein an intermediate product is transferred between two of the operation terminals, and at least one final product is received by at least one of the operation terminals; wherein the at least one project starting signal is associated with the project dispatching signal;
selectively storing the assigned task assignment sequence into the task assignment database as one of the multiple candidate task assignment sequences by the processor; and
generating at least one base score at least associated with the assigned task assignment sequence, computing a representative score of one of the candidate task assignment sequences corresponding to the assigned task assignment sequence based on the at least one base score, and storing the representative score into the task assignment database by the processor.

In another embodiment, the project task assignment method includes:
building a task assignment database and an execution terminal database in the storage device by the processor; wherein the task assignment database stores multiple candidate project types, and the execution terminal database stores multiple feedback data associated with multiple execution terminals;
receiving a project dispatching signal from the demand terminal, and acquiring an assigned project type and project detail data according to the project dispatching signal by the processor; wherein the assigned project type is one of the candidate project types;
determining an assigned task assignment sequence according to the project dispatching signal, and generating multiple matching scores corresponding to at least one part of the execution terminals by the processor; wherein one of the matching scores represents a matching degree between first data and second data; wherein the first data comprises the feedback data of one of the execution terminals, and the second data comprises the assigned project type and the project detail data;
acquiring multiple operation terminals at least based on the matching scores by the processor; wherein the operation terminals are one part of the execution terminals corresponding to the matching scores;
transmitting at least one project starting signal to at least one of the operation terminals according to the assigned task assignment sequence by the processor; wherein an intermediate product is transferred between two of the operation terminals, and at least one final product is received by at least one of the operation terminals; wherein the at least one project starting signal is associated with the project dispatching signal;
selectively storing the assigned task assignment sequence into the task assignment database as one of the multiple candidate task assignment sequences by the processor; and
receiving a final product score associated with the final product from the demand terminal, generating at least one base score associated with a final product score, computing a representative score of one of the candidate task assignment sequences corresponding to the assigned task assignment sequence based on the at least one base score, and storing the representative score into the task assignment database by the processor.

In another embodiment, the project task assignment method includes:
building a task assignment database and an execution terminal database in the storage device by the processor; wherein the task assignment database stores multiple candidate project types, the execution terminal database stores multiple feedback data associated with multiple execution terminals, and one of the feedback data is associated with a feedback task assignment sequence;
receiving a project dispatching signal from the demand terminal, and acquiring an assigned project type and project detail data according to the project dispatching signal by the processor; wherein the assigned project type is one of the candidate project types;
determining an assigned task assignment sequence according to the project dispatching signal, and generating multiple matching scores corresponding to at least one part of the execution terminals by the processor; wherein one of the matching scores represents a matching degree between first data and second data; wherein the first data comprises the feedback data of one of the execution terminals, and the second data comprises the assigned project type and the project detail data;
acquiring multiple operation terminals at least based on the matching scores by the processor; wherein the operation terminals are one part of the execution terminals corresponding to the matching scores;
transmitting at least one project starting signal to at least one of the operation terminals according to the assigned task assignment sequence by the processor; wherein an intermediate product is transferred between two of the operation terminals, and at least one final product is received by at least one of the operation terminals; wherein the at least one project starting signal is associated with the project dispatching signal;
selectively storing the assigned task assignment sequence into the task assignment database as one of the multiple candidate task assignment sequences by the processor; and
generating at least one base score associated with the feedback task assignment sequence, computing a representative score of one of the candidate task assignment sequences corresponding to the feedback task assignment sequence based on the at least one base score, and storing the representative score into the task assignment database by the processor.

Other objectives, advantages and novel features of the invention will become more apparent from the following detailed description when taken in conjunction with the accompanying drawings.

### BRIEF DESCRIPTION OF THE DRAWINGS

FIG. 1 is a schematic diagram of at least one task assignment sequence of a social media post project;

FIG. 2 is a block diagram of a project task assignment system of one embodiment of the present invention;

FIG. 3 is a stage diagram of a project task assignment method of one embodiment of the present invention;

FIG. 4 is a flowchart of a building stage of a task assignment database of one embodiment of the present invention;

FIG. 5 is a flowchart of a building stage of an execution terminal database of one embodiment of the present invention;

FIG. 6 is a flowchart of a task assigning stage of one embodiment of the present invention;

FIG. 7 is a flowchart of a task executing stage of one embodiment of the present invention; and

FIG. 8 is a flowchart of a score setting stage of one embodiment of the present invention.

### DETAILED DESCRIPTION OF THE INVENTION

The detailed features and characteristics of the present invention are described in detail below in the embodiments, and content of the embodiments is sufficient to enable any person familiar with the relevant art to understand the technical content of the present invention and implement it accordingly. According to the content disclosed in the present invention, the claims of the present invention, and the drawings of the present invention, anyone who is familiar with the related art can easily understand the ideas and features related to the present invention.

The following examples further describe the concept of the present invention in detail, but do not limit the scope of the present invention in any way.

The present invention is a project task assignment method executed by a project task assignment system. First of all, commonly used vocabulary when describing the present invention is defined as follows in advance here.

At least one “project” is a case that needs to be completed by various talents with different professions. Namely, a demand terminal can initiate a project, and operation terminals can be selected from multiple selectable execution terminals. The demand terminal may represent a manufacturer or a business executive. The execution terminals may represent all outsourced personnel or all staffs in the enterprise or the intermediary platform. The operation terminal may represent a person included in the personnel, and the person is the one who executes a task of the project.

At least one “project type” may refer to a type of said project according to a content to be completed. For example, the project type may be a social media post type, a website development type, a video production type, etc.

At least one “professional type” may refer to types of professional skills required to complete various projects. For example, a social media post project may need persons who have professional skills of marketing planning, graphic planning, copywriting, and graphic designing, such as a marketing planner, a graphic planner, a copywriter, and a graphic designer.

At least one “professional task assignment” may refer to task assignment and process planning for the professional types of the project type, and the professional task assignment may include at least one professional task assignment combination and at least one professional task assignment sequence.

The “professional task assignment combination” hereinafter is referred to as a “task assignment combination”. The task assignment combination may refer to a professional assigning method for completing the project, that is, all collections of the professional types needed for completing the project. For example, the said four professional types of the social media post project (marketing planning, graphic planning, copywriting, and graphic designing) form one of the task assignment combinations.

The “professional task assignment sequence” hereinafter is referred to as a “task assignment sequence”. Taking into account the practical situation, the task assignment sequence may refer to an execution sequence of all the professional types in the task assignment combination of one project. For example, in a practical implementation of a social media post project, the copywriting usually starts after the marketing planning, or in an audio-visual production project, a video shooting is usually performed before a video editing.

Since one project can be completed using a variety of different processing methods, and different processing methods may require different collections of the professional types, the said project may cover multiple task assignment combinations. Further, since the professional types in each task assignment combination may also be executed in different sequences, the task assignment combinations may cover multiple task assignment sequences.

In addition, since any task assignment sequence includes multiple professional types required to complete the project, this task assignment sequence must necessarily imply the task assignment combinations formed by the professional types.

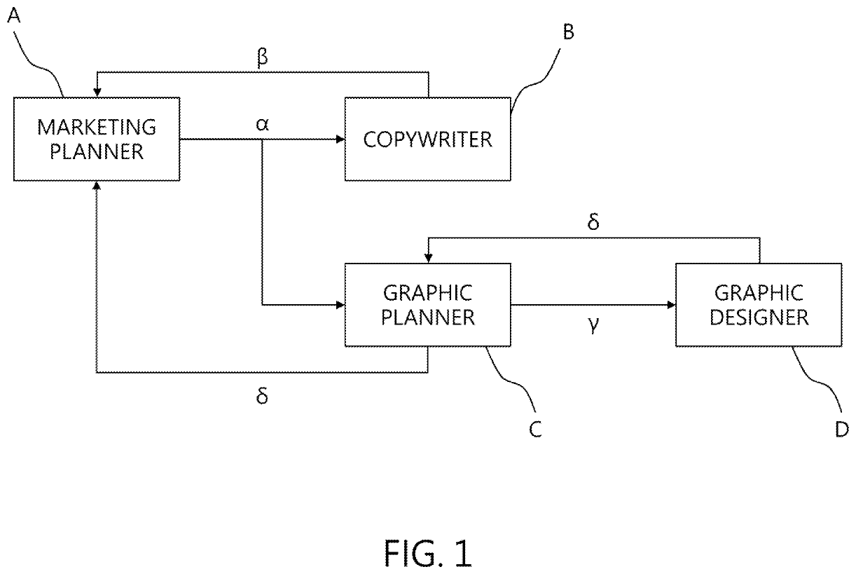

With reference to FIG. 1, a schematic diagram of the task assignment sequence of the said social media post project is shown to illustrate the task assignment sequence of the project task assignment method in this case.

To be more specific, in this task assignment sequence, after a marketing planner A produces a marketing plan (product α), a subsequent copywriter B completes the copywriting draft (product β) based on the marketing plan, and then the marketing planner A confirms the copywriting draft. On the other hand, after a graphic planner C produces a graphic plan (product γ) based on the marketing plan, a graphic designer D produces a graphic draft (product δ) based on the graphic plan, and then the graphic planner C and the marketing planner A confirm the graphic draft. Finally, the marketing planner A produces a final product including the copywriting draft and the graphic draft.

The above task assignment sequence can be recorded as “A(B&CDC)A”. A symbol of “&” represents a relationship of “parallel processing without affecting each other”. A symbol of “(”represents that multiple following professional types receive one product produced by one previous professional type. For example, a record of “A(B&C” represents that the copywriter B and the graphic planner C receive the product α produced by the marketing planner A. Further, a record of “CDC” represents that the graphic designer D receives the product γ produced by the graphic planner C, produces the product δ according to the product γ, and transmits the product δ to the graphic planner C for confirming. A symbol of “)” represents that one following professional type receives multiple products produced by multiple previous professional types. For example, a record of “B&CDC)A” represents that the marketing planner A receives the product β produced by the copywriter B, and receives the product δ produced by the graphic designer D and confirmed by the graphic planner C.

The above described method is only an example, and does not limit this invention.

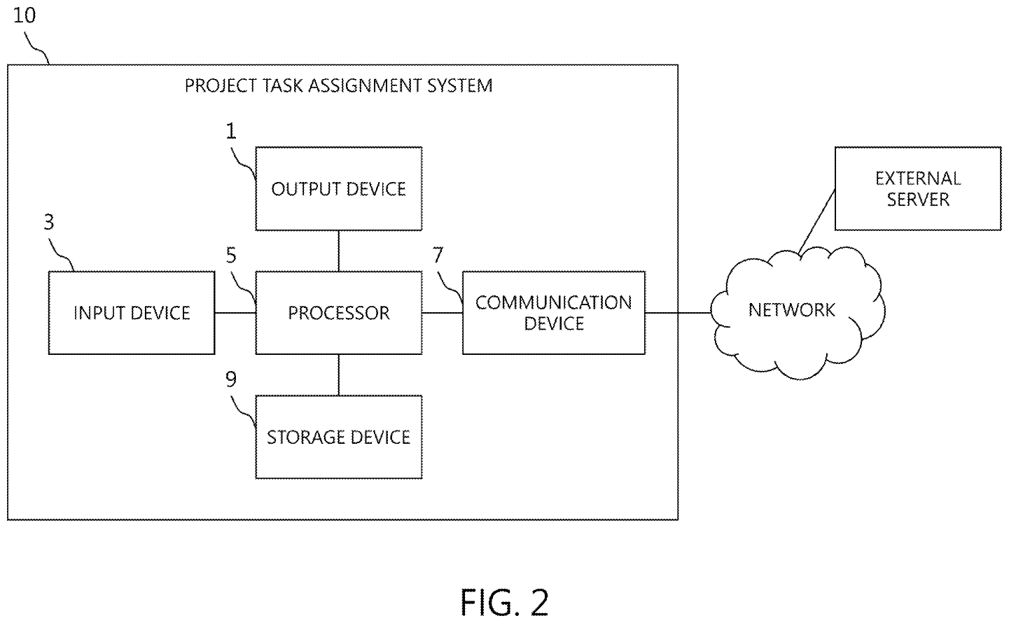

With reference to FIG. 2, FIG. 2 is a block diagram of the project task assignment system 10 of one embodiment of the present invention. The project task assignment system 10 executes the project task assignment method of the present invention.

In the embodiment, the project task assignment system 10 communicates with at least one demand terminal and multiple execution terminals, and the project task assignment system 10 includes an output device 1, an input device 3, a processor 5, a communication device 7, and a storage device 9.

The processor 5 electrically connects to the output device 1, the input device 3, the communicate device 7, and the storage device 9. The processor 5 of the project task assignment system 10 can communicate with multiple external servers thought a network N by the communication device 7. The processor 5 executes the project task assignment method described in an embodiment of the present invention.

Further, the processor 5 can receive signals through the network N by the communication device 7. For example, the processor 5 can receive the signals from the demand terminal and the execution terminals through the network N by the communication device 7. In a situation of the processor 5 can receive the signals through the network N by the communication device 7, the output device 1 and the input device 3 of the project task assignment system 10 may be omitted. The storage device 9 at least stores a task assignment database and an execution terminal database, and the storage device 9 may further store a demand terminal database.

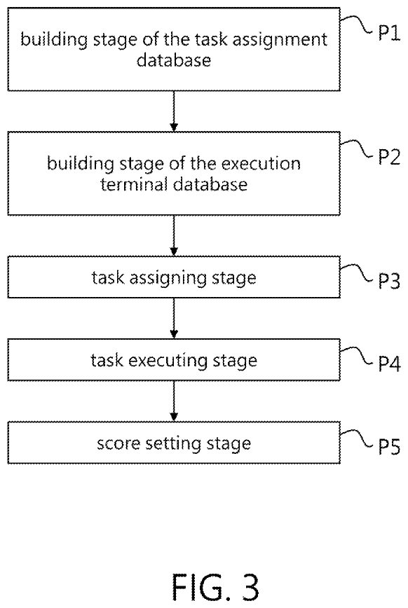

With reference to FIG. 3, FIG. 3 is a stage diagram of the project task assignment method of one embodiment of the present invention. The project task assignment method includes stages of: P1: building stage of the task assignment database; P2: building stage of the execution terminal database; P3: task assigning stage; P4: task executing stage; P5: score setting stage. Each stage is described in further detail below.

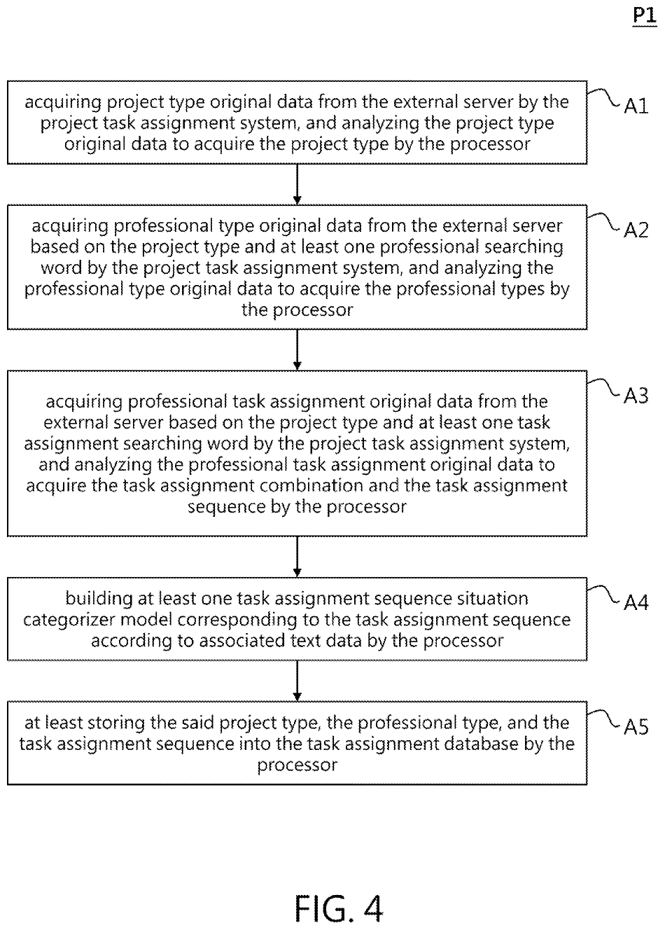

With reference to FIG. 4, FIG. 4 is a flowchart of the building stage of the task assignment database P1 of one embodiment of the present invention, and the building stage of the task assignment database P1 at least includes the following steps of A1 to A5.

Step A1 is a step of: acquiring project type original data from the external server by the project task assignment system 10, and analyzing the project type original data to acquire the project type by the processor 5. The external server may include a search engine, such as Google search engine, Baidu search engine, etc.

In practice, since a job usually involves a variety of professional skills and the job is usually a relatively common daily term, the project task assignment system 10 may connect to Google's Application Programming Interface (API) and use keywords including “job” for searching and acquire search results. For example, the keyword may be “job position”, “job classification”, and “job category”. Further, the project task assignment system 10 may use a crawler program to grab a text content of the search results as the project type original data. For example, the crawler program may include Apache Nutch, Heritrix, Aperture, Grub, etc.

Then, the processor 5 may use natural language processing technology to analyze and process the project type original data for obtaining words that meet an approval of the project type. For example, the natural language processing technology may include Keyword Extraction, Texting Mining, Finding Synonym, etc.

To be more specific, a feasible embodiment is to extract the keywords in the project type original data through the keyword extraction technology, and analyze these keywords with the association analysis method in the text mining technology to obtain the words that meet an approval of the project type. For example, the keyword extraction technology may include KeyBert which is a method of building a keyword extraction model using a semi-supervised algorithm. For example, a job position is usually followed by the job title, so words of the job title may be removed to obtain the “job category”. For example, the word “supervisor” may be removed from “marketing planning supervisor” to obtain the job category of “marketing planning”, and “marketing planning” are the words that meet the approval of the project type. In addition, after obtaining the words that meet the approval of the project type, the processor 5 can selectively filter synonyms of these words. For example, the processor 5 can choose to retain only one of the synonyms through the search and comparison of the thesaurus, such as WordNet or Chinese WordNet.

In another feasible embodiment, the keyword extraction technology is used to search websites with more job categories or project categories. The keywords in such websites can be labeled manually. Further, the labeled keywords can be used as training data to build a keyword analysis model. Then, the trained keyword analysis model can be used to extract the word that meets the approval of the project type from the project type original data, and synonyms of these words can be selectively filtered to obtain a final result. For example, the keyword extraction technology may be a method of building the keyword analysis model with machine learning algorithm, such as KeyPhrase-Extraction. The websites may be a job dictionary of the “1111 Job Bank”, a job classification of the “104 Job Bank”, an occupational standard classification in the Statistics Information Network of the Republic of China, a project classification in “518 tasker”, or a project classification in “Pro360”, etc. For example, the “1111 Job Bank” and the 104 Job Bank” are job posting sites in Taiwan. The “518 tasker” and “Pro360” are websites of online marketplaces for freelance services.

Step A2 is a step of: acquiring professional type original data from the external server based on the project type and at least one professional searching word by the project task assignment system 10, and analyzing the professional type original data to acquire the professional types by the processor 5.

When the step A2 is executed, the project task assignment system 10 uses the project type obtained in the step A1 and words to be the professional searching words and perform searching by the external server to acquire searching results. The words used for the professional searching words may be skill, specialty, or a combination thereof.

Then, the processor 5 uses the same method as step A1 to grab the text content of the search results as the professional type original data with the crawler program, and the processor 5 finds out the keywords of the professional type original data with the keyword extraction technology.

Finally, the keywords are analyzed with a text mining technology, for example, deleting the keywords which are same as the project type, and use the one that appears more frequently as the professional type. Similarly, synonyms can be selectively filtered before analysis by text mining technology.

Step A3 is a step of: acquiring professional task assignment original data from the external server based on the project type and at least one task assignment searching word by the project task assignment system 10, and analyzing the professional task assignment original data to acquire the task assignment combination and the task assignment sequence by the processor 5.

In one embodiment, similar with the step A2, the project task assignment system 10 uses the project type obtained in the step A1 and words to be the task assignment searching words and perform searching by the external server to acquire searching results. The words used for the task assignment searching words may be assignment, process, or a combination thereof.

Then, the processor 5 uses the same method as step A1 to grab the text content of the search results as the professional task assignment original data with the crawler program, and the processor 5 finds out the keywords of the professional task assignment original data with the keyword extraction technology. Further, the keywords are analyzed with the text mining technology to obtain the task assignment combination and the task assignment sequence.

Specifically, in one embodiment of the analysis using text mining technology, the professional types obtained according to one project type can be compared with keywords in a text corresponding to the project type. The text corresponding to the project type includes the professional task assignment original data. Further, the task assignment combination and the task assignment sequence can be defined according to a number of times and orders of the keywords in the text that are obtained by comparison.

For example, when multiple professional types recorded immediately after the project type meet a first preset condition, such as, when a number of times of the professional types appear together in the text is greater than a combination threshold value, the task assignment combination including the professional types can be obtained. When records appearing in a certain order in the text meet a second preset condition, such as, when a number of times of the professional types are recorded in the certain order in the text is greater than a sequence threshold value, the task assignment sequence can be obtained. Likewise, synonyms can be selectively filtered before analysis by text mining techniques.

Step A4 is a step of: building at least one task assignment sequence situation categorizer model corresponding to the task assignment sequence according to associated text data by the processor 5.

In one embodiment, the processor 5 uses the text of the professional task assignment original data used to obtain the task assignment sequence in the step A3 to perform a machine learning training, and further builds the task assignment sequence situation categorizer model corresponding to the task assignment sequence.

For example, the processor 5 performs text preprocessing on the text to deal with word encoding problems, to perform word segmentation, and to remove stop words, etc. Further, the preprocessed text is vectorized into a real number vector by a word embedding method. The word embedding method can be a frequency-based method, such as Count Vector, TF-IDF Vector, etc., or a prediction-based method, such as Word2vec, Doc2Vec, GloVe, etc. Finally, the task assignment sequence situation categorizer model corresponding to the task assignment sequence is trained by using the said real number vector through a machine learning algorithm. The machine learning algorithm can be, for example, a Support Vector Machine, a Naive Bayes Classifier, a Neural Network, a deep learning, and the like.

Step A5 is a step of: at least storing the said project type, the professional type, and the task assignment sequence into the task assignment database by the processor 5.

In this step, the project type, the professional type, and the task assignment sequence stored in the task assignment database are respectively called the candidate project type, candidate professional type, and candidate task assignment sequence.

In addition, the processor 5 can also store the task assignment combination and the task assignment sequence situation categorizer model in the task assignment database in this step.

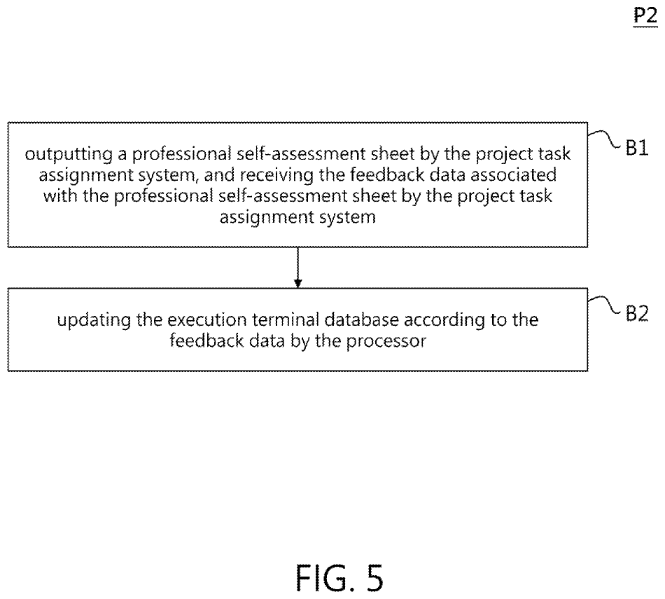

With reference to FIG. 5, FIG. 5 is a flowchart of the building stage of the execution terminal database P2 of one embodiment of the present invention, and the building stage of the execution terminal database P2 at least includes the following steps of B1 and B2.

Step B1 is a step of: outputting a professional self-assessment sheet by the project task assignment system 10, and receiving the feedback data associated with the professional self-assessment sheet by the project task assignment system 10. The professional self-assessment sheet is provided to the execution terminal, and the execution terminal can generate and return a setting signal including the feedback data according to the professional self-assessment sheet.

The project task assignment system 10 can provide the candidate project types, the candidate professional types, and the candidate task assignment sequences in the professional self-assessment sheet for selection by the execution terminal.

In addition, the professional self-assessment sheet further includes other fields to provide for receiving a professional ability description of the execution terminal and/or an execution time of certain candidate professional type.

The processor 5 can display the professional self-assessment sheet through the output device 1, such as a screen, or the processor 5 can output the professional self-assessment sheet to the execution terminal through the communication device 7.

Step B2 is a step of: updating the execution terminal database according to the feedback data by the processor 5. When the processor 5 receives the said setting signal, the processor 5 further creates or modifies data associated with the execution terminal in the execution terminal database according to the setting signal.

In detail, the feedback data is a reply from the execution terminal to the professional self-assessment sheet. The feedback data must include the feedback project type, and further at least includes the professional ability description and one of the feedback professional types.

When the feedback data includes the description of professional ability but does not include the feedback professional type, the processor 5 can use the same method as step A1 to find the keywords in the professional ability description by the keyword extraction technology, and the processor 5 analyzes the keywords with the text mining technology to acquire the feedback professional type.

In addition, the feedback data preferably includes at least one feedback task assignment sequence. However, when the feedback data includes the professional ability description but does not include the feedback task assignment sequence, the processor 5 can perform natural language processing on the professional ability description to acquire the feature vector, and then the processor 5 sends the feature vector to the task assignment sequence situation categorizer model of each candidate task assignment sequence under the feedback project type for evaluation. Finally, the feedback task assignment sequence can be deduced to be the candidate task assignment sequence of the task assignment sequence situation categorizer model having the highest evaluation score.

In one embodiment, the feedback project type can be at least one of the candidate project types. The feedback professional type can be at least one of the candidate professional types. The feedback task assignment sequence can also be at least one of the candidate task assignment sequences.

However, no matter the feedback project type, the feedback professional type, or the feedback task assignment sequence, it can be generated by the execution terminal itself, rather than one of the candidate project types/the candidate professional types/the candidate task assignment sequences.

In addition, the professional ability description included in the feedback data may be, for example, a brief experience introduction of the execution terminal and/or an expertise description of the execution terminal. The execution time can be a time period evaluated by the execution terminal to execute the feedback professional type under the feedback project type.

The processor 5 can receive the setting signal through the input device 3, such as a keyboard, a mouse, or a virtual menu in a graphical interface, or the processor 5 can obtain the setting signal through the communication device 7.

The above mentioned building stage of the task assignment database P1 and the building stage of the execution terminal database P2 both can be executed repeatedly to continuously expand the task assignment database and the execution terminal database of the project task assignment system 10.

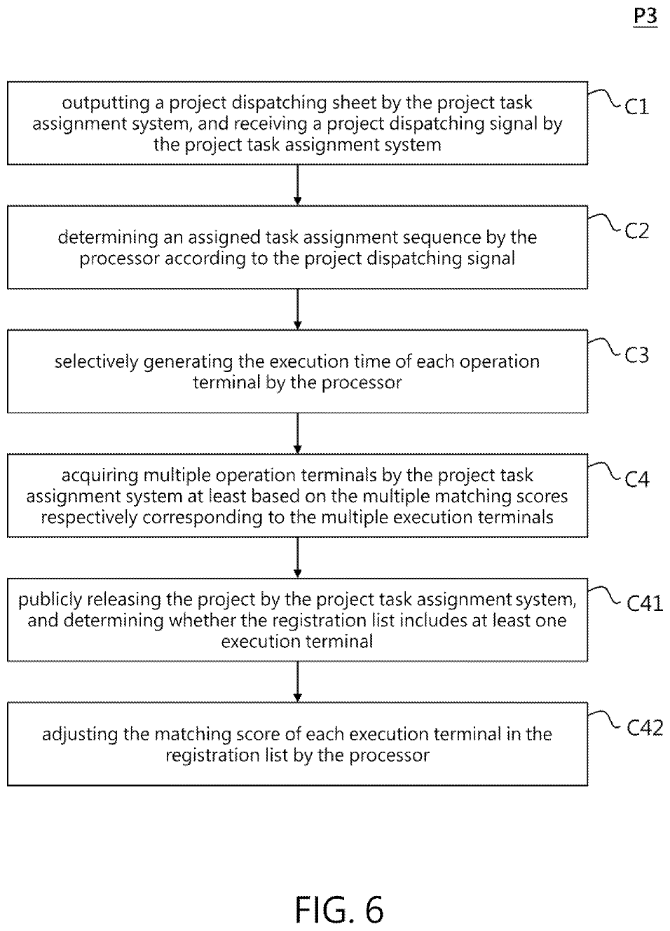

With reference to FIG. 6, FIG. 6 is a flowchart of the task assigning stage P3 of one embodiment of the present invention, and the task assigning stage P3 at least includes the following steps of C1 to C4.

Step C1 is a step of: outputting a project dispatching sheet by the project task assignment system 10, and receiving a project dispatching signal by the project task assignment system 10. The project dispatching sheet is outputted to the demand terminal, and the project dispatching signal is received from the demand terminal. For example, the project dispatching sheet can be displayed by the output device 1, and the project dispatching signal can be received by the input device 3. For another example, the project dispatching sheet can be outputted through the communication device 7, and the project dispatching signal can be received through the communication device 7. Login data of the said demand terminal may be pre-stored in the demand terminal database.

In one embodiment, the project dispatching sheet can include multiple setting items, such as a project type and a case requirement. Moreover, the project dispatching sheet may further include other setting items, such as a task assignment sequence, an execution time, and an operation terminal restriction. The project dispatching signal may include response contents of the demand terminal to the setting items.

The following is a detailed description of the project dispatching sheet and the project dispatching signal based on each setting item.

For the setting item of the project type, the project dispatching sheet can display all of the candidate project types in the setting item of the project type. The project dispatching signal corresponding to the setting item of the project type can include the project type selected from the candidate project types by the demand terminal, and the project type selected from the candidate project types by the demand terminal hereinafter is referred to as the assigned project type.

For the setting item of the case requirement, the project dispatching sheet can display an interface for inputting or uploading the text. The project dispatching signal corresponding to the setting item of the case requirement includes the text describing project details by the demand terminal.

For the setting item of the task assignment sequence, the project dispatching sheet can display multiple candidate task assignment sequences of the assigned project type after the assigned project type is obtained, or the project dispatching sheet may directly display all the candidate task assignment sequences stored in the task assignment database. The project dispatching signal corresponding to the setting item of the task assignment sequence may include the candidate task assignment sequence selected by the demand terminal, or may include a new task assignment sequence generated by the demand terminal instead of one of the candidate task assignment sequences. In addition, when the candidate task assignment sequence includes a representative score, the setting item of the task assignment sequence can display the candidate task assignment sequences according to the representative scores from high to low. The representative score will be described in detail later.

For the setting item of the execution time, the project dispatching sheet can include a column for filling in the execution time of the entire project, and/or the project dispatching sheet can further include other column for filling in the execution time of each professional type of the task assignment sequence which is selected or generated. The project dispatching signal corresponding to the execution time is a time period or an estimated completion date provided by the demand terminal for the said column.

For the setting item of the operation terminal restriction, the project dispatching sheet can include fields for filling in restrictions of each operation terminal. The project dispatching signal corresponding to the setting item of the operation terminal restriction is a text of the restriction provided by the demand terminal. For example, the text of the restriction may include years of employment, expertise, experience, and ability description of the operation terminal.

Step C2 is a step of: determining an assigned task assignment sequence by the processor 5 according to the project dispatching signal. For the convenience of understanding, regardless that data related to a response content of the setting items other than the setting item of the project type is obtained from the project dispatching signal or generated by the processor 5, the data is collectively referred to later as the project detail data.

In Step C2, if the project dispatching signal includes the response content corresponding to the setting item of the task assignment sequence, the assigned task assignment sequence is the candidate task assignment sequence selected by the demand terminal or a new task assignment sequence generated by the demand terminal.

If the project dispatching signal does not include the response content corresponding to the setting item of the task assignment sequence, the response content corresponding to the assigned task assignment sequence can be generated by the following methods. In an embodiment of at least one of the candidate task assignment sequences having a representative score, the processor 5 may determine the candidate task assignment sequence of the assigned project type having the highest representative score to be the assigned task assignment sequence. Or, the processor 5 may process the response content corresponding to the setting item of the case requirement in the project dispatching signal (or the response content corresponding to the setting item of the case requirement and the setting item of the operation terminal restriction in the project dispatching signal) by natural language processing to acquire a feature vector. Then, the processor 5 further inputs the feature vector into the task assignment sequence situation categorizer model of each candidate task assignment sequence of the assigned project type for scoring. Finally, the processor 5 assigns the candidate task assignment sequence of the task assignment sequence situation categorizer model having the highest score as the assigned task assignment sequence.

After the assigned task assignment sequence is determined, the at least one assigned professional type required to complete the assigned task assignment sequence can be obtained together as one part of the project detail data.

Step C3 is a step of: selectively generating the execution time of each operation terminal by the processor 5. When the project dispatching signal does not include the response content corresponding to the setting item of the execution time, the processor 5 generates the response content, that is, the processor 5 generates the execution time of each operation terminal.

The execution time may be generated by the following three embodiments. In a first embodiment, the processor 5 averages the execution time of the same feedback professional type for each assigned professional type according to the execution time that all of the execution terminals of the execution terminal database provide to the feedback professional type, and then the processor 5 can compute the execution time of each assigned professional type of the assigned task assignment sequence. In a second embodiment, the processor 5 calculates a weighted average according to historical actual execution time of all of the execution terminals including the feedback professional types which are same as the assigned professional types. In a third embodiment, the processor 5 calculates a weighted average as the execution time of the operation terminal according to the past execution time that was responded by the demand terminal in the setting item of the execution time associated with the project dispatching signal and recorded in the demand terminal database.

Step C4 is a step of: acquiring multiple operation terminals by the project task assignment system 10 at least based on the multiple matching scores respectively corresponding to the multiple execution terminals. Each matching score is associated with at least one consideration factor of the execution terminal corresponding to the matching score. The consideration factor may include at least one of the assigned project type, the assigned task assignment sequence, the assigned professional type, the case requirement, the operation terminal restriction, and the execution time.

Specifically, in step C4, for each execution terminal of the execution terminal database, the processor 5 can acquire the matching score of the execution terminal by weighted calculating the matching degrees after comparing the matching degrees between the feedback data of the execution terminal to be evaluated and the above consideration factor.

Subsequently, the project task assignment system 10 assigns the execution terminal of each assigned professional type with the highest matching score as each operation terminal to operate the project.

Alternatively, the project task assignment system 10 displays a candidate list according to the matching score from high to low, and then the project task assignment system 10 receives a selection signal generated by the demand terminal and associated with the candidate list to determine the operation terminals. The selection signal includes the operation terminal that is selected from the candidate list by the demand terminal, and the selected operation terminal is used to operate the project.

A comparison method of each matching degree performed by the processor 5 can be described later.

For the comparison method of the matching degree of the assigned project type, the processor 5 compares characters of the feedback project type of the execution terminal with characters of the assigned project type. When the characters are the same, the feedback project type and the assigned project type can be considered to match, and then the matching degree is defined as 1, otherwise the matching degree is defined as 0.

For the comparison method of the matching degree of the assigned task assignment sequence, the processor 5 compares minimum edit distances, such as the Levenshtein distance, between the feedback task assignment sequences and the assigned task assignment sequence. Then, the processor 5 acquires the matching degrees between the feedback task assignment sequences and the assigned task assignment sequence based on the minimum edit distance of each feedback task assignment sequence and the assigned task assignment sequence. Namely the minimum edit distances are calculated by the Levenshtein distance algorithm.

For example, the processor 5 selects the largest one of all of the minimum edit distances as a denominator, the processor 5 normalizes all of the minimum edit distances to obtain normalized distances, and the processor 5 determines differences between 1 and the normalized distances to be the matching degrees.

Preferably, the execution terminal for comparing the matching degrees of the assigned task assignment sequence can be the execution terminal whose matching degree between the feedback project type of the execution terminal and the assigned project type reaches a preset level instead of all of the execution terminals in the execution terminal database. For example, when the matching degree between the feedback project type of the execution terminal and the assigned project type is equal to 1, the matching degree reaches the preset level. Therefore, a calculation of the processor 5 can be effectively reduced.

For the comparison method of the matching degree of the assigned professional type, the processor 5 compares characters of the feedback professional type of the execution terminal with characters of all of the assigned professional types in the assigned task assignment sequence. When the characters of the feedback professional type is the same as the characters of at least one assigned professional type, the two having the same characters can be considered to match, and then the matching degree is defined as 1, otherwise the matching degree is defined as 0.

For the comparison method of the matching degree of the case requirement, based on the professional ability description of each execution terminal in the execution terminal database, the processor 5 performs character comparison with the case requirement in text form in the project dispatching signal to acquire the matching degree of the case requirement.

Similarly, for the matching degree of the operation terminal restriction, based on the professional ability description of each execution terminal of the execution terminal database, the processor 5 performs character comparison with the operation terminal restriction of the project dispatching signal to acquire the matching degree of the operation terminal restriction.

In one embodiment, the processor 5 can obtain keywords of the professional ability description and the case requirement/the operation terminal restriction by the keyword extraction technology. Then, the processor 5 can determine the matching degree according to the number of similar keywords between the professional ability description and the case requirement/the operation terminal restriction. The processor 5 further can use the largest matching degree as the denominator to normalize all of the matching degrees of the case requirement/the operation terminal restriction of all of the execution terminals to a value between 0 and 1.

Similar with the comparison method of the matching degree of the assigned task assignment sequence, when comparing the matching degree of the case requirement/the operation terminal restriction, preferably, the processor 5 only compares the execution terminal whose matching degree of the assigned project type reaches a preset degree.

For the comparison method of the matching degree of the execution time, based on the execution time of each feedback professional type of each execution terminal in the execution terminal database or an average execution time of the feedback professional type that the execution terminal has executed multiple times, the processor 5 performs a difference calculation with the execution time of the assigned professional type corresponding to each feedback professional type of each execution terminal in the project dispatching signal or the execution time corresponding to the assigned professional type generated in step C3. Then, the processor 5 further acquires the matching degree based on the differences.

For example, the processor 5 uses the maximum of the differences as the denominator, and the processor 5 normalizes the differences of the execution time of the assigned professional types of all of the execution terminals to obtain normalized differences. The processor 5 further calculates differences between 1 and the normalized differences, and the processor 5 uses the calculated differences between 1 and the normalized differences as the matching degree of the execution time.

In addition, in one embodiment, the matching scores used in the step C4 may be further associated with a registration list in addition to the consideration factor mentioned above.

Specifically, please refer to FIG. 6 again: the task assigning stage P3 executed by the processor 5 may further include step C41 to C42. Step C41 is a step of: “publicly releasing the project by the project task assignment system 10, and determining whether the registration list includes at least one execution terminal”. Step C42 is a step of: “adjusting the matching score of each execution terminal in the registration list by the processor 5”.

In one embodiment, in step C41, the project task assignment system 10 publicly releases data. The data is provided by the project dispatching signal or is calculated according to the project dispatching signal. The data may include the assigned project type, the assigned task assignment sequence, the case requirement, the execution time, and the execution terminal restriction, etc. After a predetermined time period, the project task assignment system 10 further determines whether the registration list of the execution terminal which is used to store registration data includes the execution terminal which registers the project. If “yes”, the project task assignment system 10 adjusts the matching scores of the execution terminals in step C42. For example, the project task assignment system 10 updates the matching scores by adding a positive number or multiplying by a number more than 1. If “no”, the matching scores of the execution terminals are maintained.

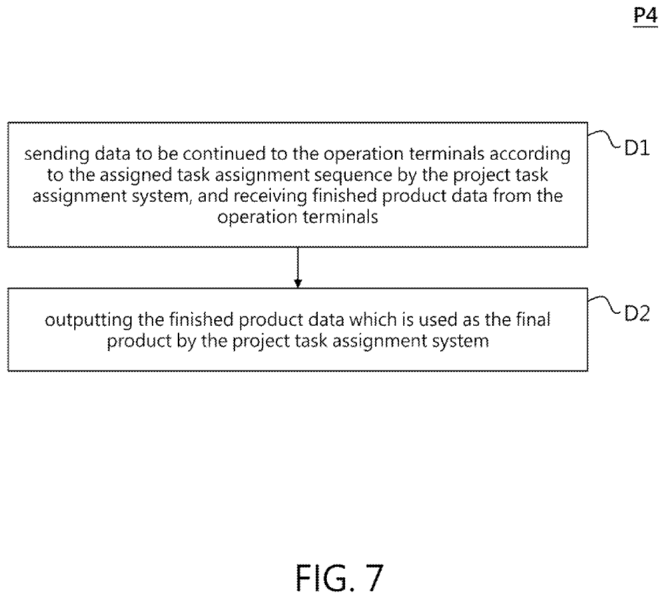

With reference to FIG. 7, FIG. 7 is a flowchart of the task executing stage P4 of one embodiment of the present invention, and the task executing stage P4 may include the following steps of D1 and D2.

Step D1 is a step of: sending data to be continued to the operation terminals according to the assigned task assignment sequence by the project task assignment system 10, and receiving finished product data from the operation terminals.

The data to be continued can be a project starting signal generated by the processor 5 according to the project dispatching signal or an intermediate product, and the finished product data can be the final product or the intermediate product. For example, for the operation terminal that executes the first task in the assigned task assignment sequence, the data to be continued can be the project starting signal generated by the processor 5 according to the project dispatching signal. For the operation terminal other than the operation terminal that executes the first task, the data to be continued can be the intermediate product.

The finished product data can be a final product or an intermediate product. For the operation terminal that executes the last task in the assigned task assignment sequence, the finished product data can be the final product. For the operation terminal other than the operation terminal that executes the last task, the finished product data can be the intermediate product.

The said project starting signal at least includes a case requirement.

In step D1, the processor 5 can transmit the intermediate product produced by the one or more operation terminals that have a previous sequence to the one operation terminal that has a following sequence according to the assigned task assignment sequence. Or the processor 5 can transmit the intermediate product produced by the one operation terminal that has a previous sequence to the one or more operation terminals that have a following sequence according to the assigned task assignment sequence.

For example, please refer to FIG. 1 again: the professional types such as the marketing planner A, the copywriter B, the graphic planner C, and the graphic designer D, can be executed by different operation terminals. However, multiple professional types of all of the professional types in the assigned task assignment sequence can also be performed by the same one operation terminal.

In one embodiment of all of the professional types being respectively executed by different operation terminals, according to the assigned task assignment sequence, the operation terminal that executes the marketing planner A hereinafter is referred to as an operation terminal Ec1. The operation terminal Ec1 is the operation terminal that has a sequence previous to sequences of the operation terminal that executes the copywriter B and the operation terminal that executes the graphic planner C. The operation terminal that executes the copywriter B hereinafter is referred to as an operation terminal Ec2. The operation terminal that executes the graphic planner C hereinafter is referred to as an operation terminal Ec3. The project starting signal is the data to be continued of the operation terminal Ec1. The intermediate product generated by the operation terminal Ec1 is not only the finished product data of the operation terminal Ec1, but also the data to be continued of the operation terminal Ec2 and the operation terminal Ec3. The operation terminal Ec3 has a sequence previous to a sequence of the operation terminal that executes the graphic designer D, and the operation terminal that executes the graphic designer D hereinafter is referred to as an operation terminal Ec4.

However, according to the assigned task assignment sequence, since the operation terminal Ec2 and the operation terminal Ec4 need to provide their finished product data to the operation terminal Ec1 and the operation terminal Ec3 for inspection respectively, the operation terminal Ec2 and the operation terminal Ec4 further respectively have sequences previous to sequences of the operation terminal Ec1 and the operation terminal Ec3. According to the assigned task assignment sequence, the operation terminal Ec1 is the last operation terminal. Therefore, the finished product data of the operation terminal Ec1 is the final product. However, in the assigned task assignment sequence wherein the finished product data does not need to be inspected, the uninspected finished product data is also the final product. For example, when the assigned task assignment sequence is A(B&CD)), the operation terminal Ec2 and the operation terminal Ec4 are two final operation terminals, and the finished product data of the operation terminal Ec2 and the operation terminal Ec4 are all final products.

Step D2 is a step of: outputting the finished product data which is used as the final product by the project task assignment system 10. Namely, the implementation results of the entire project can be provided to the demand terminal in this step D2.

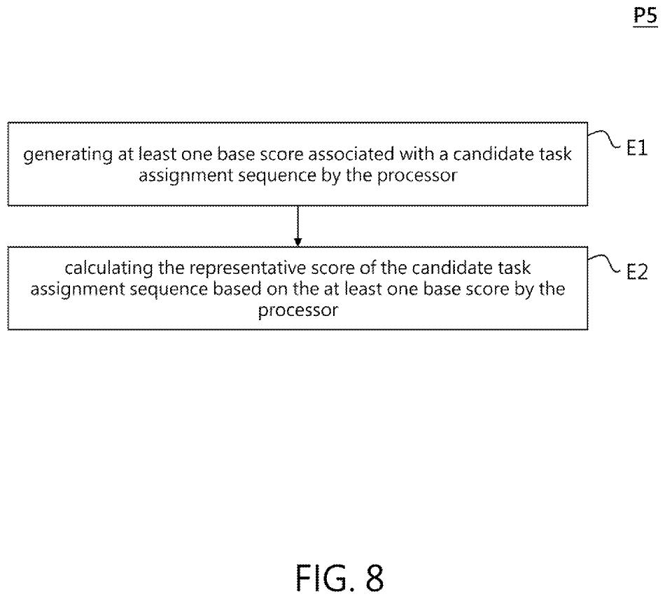

With reference to FIG. 8, FIG. 8 is a flowchart of the score setting stage P5 of one embodiment of the present invention, and the score setting stage P5 may include steps of E1 to E2. The step E1 is used for generating a base score associated with a candidate task assignment sequence. The step E2 is used for establishing or updating a representative score of the candidate task assignment sequence in the task assignment database according to the base score.

The step E1 is a step of: generating at least one base score associated with a candidate task assignment sequence by the processor 5.

For example, the candidate task assignment sequence corresponds to the assigned task assignment sequence. Then, the processor 5 can generate at least one kind of base score in the following two kinds of the base scores.

The processor 5 generates a first base score for the candidate task assignment sequence which is assigned as the assigned task assignment sequence, and the first base score can be a real number greater than 0. For example, the first base score can be set to 1 point.

Alternatively, the processor 5 generates a second base score associated with a final product score. The final product score is the score received by the project task assignment system 10 from the demand terminal and associated with a satisfaction of the final product. The final product score also corresponds to the assigned task assignment sequence. The second base score can be a real number greater than or equal to 0. For example, a full score of the satisfaction of the final product may be used as a denominator to normalize the final product score to make the second base score between 0 and 1.

In addition, when the candidate task assignment sequence corresponds to the feedback task assignment sequence, the processor 5 generates a third base score associated with the feedback task assignment sequence in the building stage of the execution terminal database P2. The third base score is also a real number greater than 0. For example, the third base score can be set as 1 point in conjunction with the first base score and the second base score.

Regarding the first to third base scores mentioned above, the processor 5 may not be able to set the second base score because the demand terminal does not provide the final product score. The processor 5 may not be able to set the third base score because the execution terminal does not provide the feedback task assignment sequence and the professional ability description. However, since the project needs to execute the task executing stage P4 according to the assigned task assignment sequence, the processor 5 must be able to obtain the first base score.

The step E2 is a step of: calculating the representative score of the candidate task assignment sequence based on the at least one base score by the processor 5.

In one embodiment, when the candidate task assignment sequence does not have an original representative score, the processor 5 can establish the representative score of the candidate task assignment sequence corresponding to the assigned task assignment sequence according to the first base score, the second base score, or a weighted average of the first and second base scores. When the candidate task assignment sequence has the original representative score, the processor 5 can acquire an updated representative score by weighted calculating the calculated representative score and the original representative score. For example, the said weighted calculation can be adding the calculated representative score and the original representative score together.

Similarly, the processor 5 can also use the same method to establish or update the representative score of the candidate task assignment sequence corresponding to the feedback task assignment sequence according to the third base score.

When the assigned task assignment sequence or the feedback task assignment sequence is not one of the candidate task assignment sequences previously built in the task assignment database, the processor 5 may further add the assigned task assignment sequence or the feedback task assignment sequence into the task assignment database for becoming a new candidate task assignment sequence. In addition, the processor 5 can set the representative score of the candidate task assignment sequence according to the aforementioned base score.

In particular, when the assigned task assignment sequence is not one of the candidate task assignment sequences, that is, the assigned task assignment sequence is a newly added task assignment sequence, the project task assignment system 10 further searches corresponding search results from the external server and grabs its text content based on the assigned project type and appearance sequences of the professional types of the newly added task assignment sequence. Then, the project task assignment system 10 further uses the text content as the associated text data in step A4, and executes step A4 to build the task assignment sequence situation categorizer model of the newly added task assignment sequence.

Similarly, when the feedback task assignment sequence is not one of the candidate task assignment sequences, the project task assignment system 10 also builds the task assignment sequence situation categorizer model of the feedback task assignment sequence by using the same method based on the feedback project type of the feedback task assignment sequence and appearance sequences of the professional types of the feedback task assignment sequence.

After performing the project task assignment method of the present invention for many times, the representative score of the candidate task assignment sequence of the task assignment database can be updated through the aforementioned score setting stage P5. Therefore, the task assignment sequence with high objective evaluation can be obtained to ensure the efficiency and quality of the project.

Another embodiment of the aforementioned score setting stage P5 is further described below. Particularly, differences in professionalism and execution capability between the execution terminal and the demand terminal can be executed for partition, and the representative score of each candidate task assignment sequence can be more objective.

In this embodiment, each execution terminal and the demand terminal may respectively have an influence weight to correspondingly adjust the base score of the feedback task assignment sequence or the base score of the assigned task assignment sequence. Regarding the influence weight, each project type or even each professional type of the single execution terminal/the demand terminal has one influence weight. Or, it is also possible that the single execution terminal/the demand terminal has a single influence weight.

In addition, the influence weight of the execution terminal can be stored in the execution terminal database. The influence weight of the demand terminal can be stored together with login data of the demand terminal in the demand terminal database.

The said influence weight is a weighted combination of a professional weight and an ability weight. The professional weight represents the professional ability of one professional type under one project type, such as familiarity of professional skills of the execution terminal or understanding of the professional skills of the demand terminal. The ability weight represents a personal ability which is nothing about the professional skills, such as time control, communication, attitude, cooperation degree of the execution terminal or of the demand terminal, etc.

The relationship between these three weights can be expressed by the following formula:

Wi=K1*Wp+K2*Wa Formula 1

Wi represents the influence weight, Wp represents the professional weight, and Wa represents the ability weight. K1 and K2 are weighting parameters respectively corresponding to the professional weight and the ability weight. A sum of the two weighting parameters K1, K2 is greater than 0, and preferably equal to 1. The two weighting parameters K1, K2 are all real numbers greater than or equal to 0. For example, one of the weighting parameters K1, K2 can be 0, and the other one can be 1.

The said ability weight can further include multiple sub-ability weights, and the ability weight can be a weighted average of the sub-ability weights. For example, the sub-ability weights may include a time control ability weight, a communication ability weight, an attitude ability weight, a compatibility ability weight, etc.

In detail, the ability weight can be expressed according to the following formula:

Wa=Σₓ₌₁^{m}Kₓ*Waₓ Formula 2

Wa₁ to Waₘ respectively represent the sub-ability weights, and K₁ to Kₘ are respectively weighting parameters of each sub-ability weight.

Similarly, a sum of the weighting parameters K₁ to Kₘ is greater than 0, andpreferably equal to 1, and the weighting parameters K₁ to Kₘ are all real numbers greater than or equal to 0.

The professional weight and the ability weight (or each sub-ability weight) both are obtained from mutual scoring of the demand terminal and the execution terminals assigned as the operation terminals. The said demand terminal and the said operation terminals have completed a project together. Therefore, evaluations of these demand terminals and execution terminals can be objectively obtained, and the professional weight and the ability weight can be used to more accurately calculate a utility of the task assignment sequence.

A method for generating the professional weight and the ability weight (or each sub-ability weight) and a method for adjusting the base score of the candidate task assignment sequence corresponding to the assigned task assignment sequence or the feedback task assignment sequence according to the influence weight are detailed described below.

The said professional weight and the ability weight (or each sub-ability weight) respectively have a growth parameter to determine a change degree of the weight in a next scoring.

When a number of times the demand terminal or execution terminal is scored increases, the growth parameter will also increase accordingly, so that an adjustment range of the abovementioned weights will gradually decrease and stabilize.

In detail, for each demand terminal or the execution terminals, the professional weight, or the ability weight (or each sub-ability weight) can be calculated by the following formula:

$${W}_{new} = \frac{{W}_{old} * {Ka}_{old} + {\sum }_{x = 1}^{n} {W}_{x} * {S}_{x}}{{Ka}_{old} + {\sum }_{x = 1}^{n} Wx} = \frac{{W}_{old} * {Ka}_{old} + {\sum }_{x = 1}^{n} {W}_{x} * {S}_{x}}{{Ka}_{new}} \qquad Formula 3$$

W_{new} is an updated weight of the demand terminal or the execution terminal that is scored, and the demand terminal or the execution terminal that is scored hereinafter is referred to as an evaluated terminal. W_{old} is the original weight of the evaluated terminal before this scoring. Ka_{old} is the original growth parameter of the evaluated terminal before this scoring. W₁ to Wₙ are weights of the demand terminal or the execution terminal for scoring, and the demand terminal and the execution terminal for scoring hereinafter are referred to as judging terminals. The weights W₁ to Wₙ can be equal to the professional weight, the ability weight (or the sub-ability weight), or the influence weight of W_{new}. S₁ to SWₙ are scores given by the judging terminal to the evaluated terminal. Ka_{new} is an updated growth parameter of the evaluated terminal.

In order to start the whole scoring mechanism smoothly, the project task assignment system 10 can give each execution terminal and the demand terminal an initial professional weight, an initial ability weight (or an initial sub-ability weight), and two initial growth parameters respectively corresponding to the initial professional weight and the initial ability weight. In particular, a higher initial professional weight may be given to the feedback professional type of the execution terminal.

The project task assignment system 10 can be used by the demand terminal and the operation terminals to score all the operation terminals in this project. However, in order to have a more correct evaluation of the operation terminal, the judging terminal is preferably a previous operation terminal, a next operation terminal, or the demand terminal of the operation terminal executing the project.

Similarly, all of the operation terminals can be used as the judging terminals of the demand terminal. However, in order to have a more correct evaluation of the demand terminal, it is better to use the operation terminal receiving the project starting signal as the judging terminal of the demand terminal.

The following is an example of calculating the professional weight of the operation terminal of the graphic planner C in the social media post project shown in FIG. 1.

In this example, a previous professional type of the graphic planner C is the marketing planner A, and a following professional type of the graphic planner C is the graphic designer D. Further, the operation terminal that executes graphic planner C is the evaluated terminal. The demand terminal, the operation terminal that executes the marketing planner A, and the operation terminal that executes the graphic designer D are the judging terminals. The demand terminal hereinafter is referred to as the judging terminal 1. The operation terminal that executes the marketing planner A hereinafter is referred to as the judging terminal 2. The operation terminal that executes the graphic designer D hereinafter is referred to as the judging terminal 3. Since the copywriter B and the graphic planner C are independent professional types in the task assignment sequence, the operation terminal that executes the copywriter B is not one of the judging terminals in this example.

In addition, the following example assumes that the original professional weight of the evaluated terminal in the graphic planner C of the social media post is 0.1, and the original growth parameter of the evaluated terminal in the graphic planner C of the social media post is 50. In this example, the professional weight of the judging terminal 1 is 0.002, and the judging terminal 1 gives 0.8 points to the evaluated terminal. The professional weight of the judging terminal 2 is 0.05, and the judging terminal 2 gives 0.9 points to the evaluated terminal. The professional weight of the judging terminal 3 is 0.4, and the judging terminal 3 gives 0.9 points to the evaluated terminal. In this example, a maximum score that can be given by each judging terminal is 1 point.

The updated professional weight of the evaluated terminal can be calculated by the formula 3 as shown below:

$${W}_{new} = \frac{0.1 * 50 + ( 0.002 * 0.8 + 0.05 * 0.9 + 0.4 * 0.9 )}{50 + ( 0.002 + 0.05 + 0.4 )} = \frac{5 + 0.4066}{50 + 0.452} ≅ 0.1072$$

Namely, the updated professional weight of the evaluated terminal is 0.1072. The growth parameter corresponding to the professional weight is updated to 50.452.

Similarly, the ability weight (or the sub-ability weight) of the evaluated terminal can also be obtained by the above calculation method. Finally, the influence weight can be updated based on the updated professional weight and the updated ability weight according to the formula 1. Moreover, when the ability weight includes the sub-ability weight, the influence weight can be updated further based on the sub-ability weight according to the formula 2.

As mentioned above, when the project task assignment system 10 applies the influence weight to execute the step E1 of the score setting stage P5, the processor 5 can set the first base score associated with the assigned task assignment sequence to be positively correlated with the influence weight of the demand terminal. For example, the first base score may be a product calculated by multiplying the influence weight of the demand terminal by a positive value. The processor 5 can further set the third base score associated with the feedback task assignment sequence to be positively correlated with the influence weight of the execution terminal. For example, the third base score may be a product calculated by multiplying the influence weight of the execution terminal by a positive value.

Since the score of the final product evaluated by the demand terminal not only relates to an applicability of the assigned task assignment sequence, but also relates to a profession and an ability of the operation terminal. Therefore, it is better to obtain the second base score in the following method to filter out factors caused by the operation terminal.

First, the processor 5 uses the mutual scoring between multiple operation terminals and the demand terminal with the following equation, and a personal score of a performance in the project of each operation terminal used as the said evaluated terminals can be obtained.

$$Sp = \frac{{\sum }_{x = 1}^{n} {W}_{x} * {S}_{x}}{{\sum }_{x = 1}^{n} {W}_{x}} = \frac{{\sum }_{x = 1}^{n} {W}_{x} * {S}_{x}}{kp} \qquad Formula 4$$

Sp represents the personal score of one operation terminal. kp represents a scoring coefficient of the operation terminal. W₁ to Wₙ can be the professional weight, the ability weight (or the sub-ability weight), or the influence weight of the judging terminal as mentioned above. Preferably, W₁ to Wₙ may be the influence weights. S1 to Sₙ are scores given to the operation terminal by the judging terminals.

Then, the weighted average score of the performance of all of the operation terminals in this project can be calculated by the following formula:

$$Sa = \frac{{\sum }_{x = 1}^{m} {K}_{x} * {Sp}_{x} * {kp}_{x}}{{\sum }_{x = 1}^{m} {kp}_{x}} \qquad Formula 5$$

Sa represents the weighted average score. Sp₁ to Spₘ respectively are personal scores of each operation terminal. kp₁ to kpₘ respectively are the scoring coefficients of each operation terminal. K₁ to Kₘ are weighting coefficients. For example, the weighting coefficient Kₓ of the judging terminal can be determined according to a relationship between the judging terminal and the operation terminal in the task assignment sequence.

Finally, the second base score can be calculated according to the following formula:

$$second base score = {k}_{c} * log ( \frac{final product score}{Sa} ) \qquad Formula 6$$

k_{c} is a regularization parameter. For example, when a full score of the final product score is 100, k_{c} can be 0.5 to maintain the second base score between 0 and 1. The full score of the final product score is 100, which means that the final product score is set between 0 and 100.

When a result of the formula 6 is a positive number, it indicates that the assigned task assignment sequence has a greater positive impact on the final product than the operation terminal. Conversely, when the result of formula 6 is negative number, it indicates that the assigned task assignment sequence has a smaller positive impact on the final product than the operation terminal.

Based on a mechanism of the above-mentioned sub-ability weight, the processor 5 can also adjust the ability weight of the operation terminal according to an execution ability presented by the operation terminal during the project executing process.

In detail, in one embodiment, the processor 5 can respectively calculate weight adjustment values for the sub-ability weights, such as the time control ability weight, the communication ability weight, the attitude ability weight, and the compatibility ability weight. Then, the processor 5 further adjusts the sub-ability weights by deduction based on the weight adjustment values.

For example, when the operation terminal or the demand terminal is overdue with a required response time, the processor 5 can calculate each weight adjustment value K_{T} related to the time control according to the following formula:

K_{T}=A^{t}^{_{d}} Formula 7

A is a deduction constant. The deduction constant is a real number less than 1 and greater than 0, and preferably close to 1, such as 0.9. t_{d} is an overdue time period of the execution terminal or the demand terminal. An adjustment method of the ability weight based on the weight adjustment values K_{T} can be the time control ability weight calculated by the formula 3 multiplied by K_{T} as the adjusted time control ability weight.

In addition, for example, one weight adjustment value associated with a communication can be calculated according to a number of round trips of questions and a time-consuming of a feedback. One weight adjustment value associated with an attitude can be calculated by sentiment analyzing to characters of a text of the feedback. One weight adjustment value associated with a cooperation degree can be calculated according to whether all of the questions have been answered based on the characters of the text of the feedback.

Finally, the sub-ability weights can be adjusted by the deduction based on the weight adjustment values calculated above.

In addition, the processor 5 can regularly update the candidate task assignment combinations and the candidate task assignment sequences stored in the task assignment database.

Specifically, for each candidate project type, the processor 5 will delete the candidate task assignment sequence whose representative score is lower than a threshold value. When the representative scores of all of the candidate task assignment sequences of one candidate task assignment combination are lower than the threshold value, the processor 5 can delete the one candidate task assignment combination.

Therefore, the processor 5 can automatically delete the less practical candidate task assignment sequence and the less practical candidate task assignment combinations.

In addition, the project task assignment system 10 can further improve an accuracy of personnel assignment based on the professional weight, the ability weight (or the sub-ability weight), and/or the influence weight.

For example, in the task assigning stage P3, an influence weight condition can be added to the consideration factor of the matching score. Namely, the project dispatching signal may further include a qualified value range of at least one of the said weights. Preferably, the qualified value range may have multiple grade intervals. After the project task assignment system 10 executes a numerical comparison between the influence weight of the execution terminal and the qualified value range of the influence weight condition, the project task assignment system 10 determines the matching degree of the influence weight based on a result of the numerical comparison. For example, the project task assignment system 10 determines whether the weight for the numerical comparison falls within the qualified value range, or determines the weight for the numerical comparison falls within which grade interval of the qualified value range. Therefore, a probability that the execution terminal having the highest influence weight is selected as the operation terminal can be increased.

To sum up, the project task assignment method of the present invention has a mechanism for updating the task assignment combination and the task assignment sequence. Therefore, it is possible to automatically keep the better one and remove the worse one for a large number of the task assignment combinations and the task assignment sequences.

In addition, the present invention proposes to apply concepts such as mutual evaluation of the operation terminals (even mutual evaluation of all of the operation terminals and the demand terminal) and the influence weight to the project task assignment method. However, a traditional method only can let the demand terminal to score each operation terminal individually. Therefore, a scoring mechanism proposed by the present invention is obviously better able to reflect a true professionalism of each operation terminal.

In other words, when a number of the demand terminals and a number of the operation terminals increase, the project task assignment method allows the demand terminal to more quickly obtain the task assignment combination and the task assignment sequence applicable to the project, and the project task assignment method further allows the demand terminal to find the most suitable candidate for each professional task assignment.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A project task assignment method, executed by a project task assignment system; wherein the project task assignment system comprises a storage device and a processor; wherein the processor connects to the storage device, and communicates with at least one demand terminal and multiple execution terminals; wherein the project task assignment method comprises:
building a task assignment database and an execution terminal database in the storage device by the processor; wherein the task assignment database stores multiple candidate project types, and the execution terminal database stores multiple feedback data associated with multiple execution terminals;
receiving a project dispatching signal from the demand terminal, and acquiring an assigned project type and project detail data according to the project dispatching signal by the processor; wherein the assigned project type is one of the candidate project types;
determining an assigned task assignment sequence according to the project dispatching signal, and generating multiple matching scores corresponding to at least one part of the execution terminals by the processor; wherein one of the matching scores represents a matching degree between first data and second data; wherein the first data comprises the feedback data of one of the execution terminals, and the second data comprises the assigned project type and the project detail data;
acquiring multiple operation terminals at least based on the matching scores by the processor; wherein the operation terminals are one part of the execution terminals corresponding to the matching scores;
transmitting at least one project starting signal to at least one of the operation terminals according to the assigned task assignment sequence by the processor; wherein an intermediate product is transferred between two of the operation terminals, and at least one final product is received by at least one of the operation terminals; wherein the at least one project starting signal is associated with the project dispatching signal;
selectively storing the assigned task assignment sequence into the task assignment database as one of the multiple candidate task assignment sequences by the processor; and
generating at least one base score at least associated with the assigned task assignment sequence, computing a representative score of one of the candidate task assignment sequences corresponding to the assigned task assignment sequence based on the at least one base score, and storing the representative score into the task assignment database by the processor.

2. The project task assignment method as claimed in claim 1, wherein when the representative score of one of the candidate task assignment sequences corresponding to the assigned task assignment sequence is computed based on the at least one base score by the processor, the project task assignment method comprises:
determining whether the candidate task assignment sequence has an original representative score by the processor;
if no, establishing the representative score of the corresponding candidate task assignment sequence based on the at least one base score associated with the assigned task assignment sequence by the processor;
if yes, updating the representative score of the corresponding candidate task assignment sequence by weighted calculating according to the at least one base score and the original representative score by the processor.

3. The project task assignment method as claimed in claim 1, wherein before the representative score of one of the candidate task assignment sequences corresponding to the assigned task assignment sequence is computed based on the at least one base score by the processor, the project task assignment method comprises:
receiving a final product score associated with the final product from the demand terminal by the processor;
wherein when the representative score of one of the candidate task assignment sequences corresponding to the assigned task assignment sequence is computed based on the at least one base score by the processor, the project task assignment method comprises:
computing a weighted average of a first base score and a second base score, and determining whether the candidate task assignment sequence has an original representative score by the processor; wherein the first base score is associated with the assigned task assignment sequence, and the second base score is associated with the final product score;
when the candidate task assignment sequence does not have the original representative score, establishing the representative score of the corresponding candidate task assignment sequence according to the weighted average by the processor;
when the candidate task assignment sequence has the original representative score, updating the representative score of the corresponding candidate task assignment sequence by weighted calculating according to the weighted average and the original representative score by the processor.

4. The project task assignment method as claimed in claim 1, wherein the project detail data comprises the assigned task assignment sequence;
wherein when the assigned task assignment sequence is determined according to the project dispatching signal by the processor, the project task assignment method comprises:
acquiring the assigned task assignment sequence according to the project detail data by the processor.

5. The project task assignment method as claimed in claim 1, wherein the candidate task assignment sequences belong to the candidate project type which is assigned as the assigned project type;
wherein the candidate task assignment sequences have multiple representative scores;
wherein when the assigned task assignment sequence is determined according to the project dispatching signal by the processor, the project task assignment method comprises:
assigning the candidate task assignment sequence having the highest representative score as the assigned task assignment sequence by the processor.

6. The project task assignment method as claimed in claim 1, wherein the candidate task assignment sequences belong to the candidate project type which is assigned as the assigned project type;
wherein the candidate task assignment sequences have multiple task assignment sequences situation categorizer models;
wherein when the assigned task assignment sequence is determined according to the project dispatching signal by the processor, the project task assignment method comprises: and
processing one part of the project detail data by natural language processing acquiring a feature vector, inputting the feature vector into the task assignment sequence situation categorizer models to acquire multiple scores, and assigning the candidate task assignment sequence having the highest score as the assigned task assignment sequence by the processor.

7. The project task assignment method as claimed in claim 6, wherein when the task assignment database is built in the storage device by the processor, the project task assignment method comprises:
acquiring a text associated with one of the candidate task assignment sequences by the processor;
pre-processing and vectorizing the text to obtain a real number vector by the processor; and
training one of the task assignment sequences situation categorizer models by machine learning based on the real number vector by the processor;
wherein the trained task assignment sequence situation categorizer model corresponds to the candidate task assignment sequence associated with the text.

8. The project task assignment method as claimed in claim 1, wherein the project detail data comprises at least one of the assigned task assignment sequences, multiple assigned professional types, a case requirement, an operation terminal restriction, and an execution time.

9. The project task assignment method as claimed in claim 1, wherein one of the feedback data is associated with a feedback task assignment sequence;
wherein when the multiple matching scores corresponding to at least one part of the execution terminals are generated by the processor, the project task assignment method comprises:
computing a minimum edit distance between the feedback task assignment sequence and the assigned task assignment sequence, and generating one of the matching scores based on the minimum edit distance by the processor.

10. The project task assignment method as claimed in claim 1, wherein the project detail data comprises a case requirement or an execution terminal restriction;
wherein one of the feedback data comprises a professional ability description;
wherein when the multiple matching scores corresponding to at least one part of the execution terminals are generated by the processor, the project task assignment method comprises:
acquiring first keywords of the professional ability description and second keywords of the case requirement or the execution terminal restriction by using a keyword extraction technology, and generating one of the matching scores based on a number of similar keywords between the first keywords and the second keywords by the processor.

11. The project task assignment method as claimed in claim 1, wherein the feedback data is associated with an execution time of one of multiple feedback professional types;
wherein when the multiple matching scores corresponding to at least one part of the execution terminals are generated by the processor, the project task assignment method comprises:
generating one of the matching scores at least based on a difference between a first execution time and a second execution time by the processor;
wherein the first execution time is an execution time of one of the feedback professional types of one of the execution terminals, or an average execution time of the feedback professional type that the execution terminal has executed;
wherein the second execution time is an execution time of one of the assigned professional types corresponding to the feedback professional type.

12. The project task assignment method as claimed in claim 1, wherein when the at least one base score associated with the assigned task assignment sequence is generated by the processor, the project task assignment method comprises:
computing an influence weight corresponding to the demand terminal by the processor;
wherein the influence weight is a weighted combination of a professional weight and an ability weight;
wherein the at least one base score at least associated with the assigned task assignment sequence has a positive correlation with the influence weight.

13. The project task assignment method as claimed in claim 12, wherein the ability weight comprises at least one sub-ability weight, and the at least one sub-ability weight comprises at least one of a time control ability weight, a communication ability weight, an attitude ability weight, and a compatibility ability weight.

14. The project task assignment method as claimed in claim 1, wherein when the representative score of one of the candidate task assignment sequences corresponding to the assigned task assignment sequence is computed based on the at least one base score by the processor, the project task assignment method comprises:
computing an influence weight corresponding to an evaluated terminal, modulating the at least one base score according to the influence weight, and computing the representative score of the corresponding candidate task assignment sequence based on the modulated at least one base score by the processor; wherein the evaluated terminal is the demand terminal or one of the execution terminals;
wherein the influence weight is a weighted combination of a professional weight and an ability weight;
wherein when the influence weight corresponding to the evaluated terminal is computed by the processor, the project task assignment method comprises:
computing the professional weight of the evaluated terminal according to at least one score, at least one judging terminal weight, an original growth parameter, and an original professional weight by the processor; and
computing a weighted average of the professional weight and the ability weight of the evaluated terminal to be the influence weight by the processor;
wherein the at least one score is given to the evaluated terminal by at least one judging terminal, the judging terminal weight is an influence weight or a professional weight of the at least one judging terminal, and the original growth parameter is associated with a degree of change of the professional weight of the evaluated terminal;
wherein the original professional weight is a professional weight of the evaluated terminal before the processor computes the professional weight of the evaluated terminal according to the at least one score, the at least one judging terminal weight, the original growth parameter, and the original professional weight;
wherein the at least one judging terminal comprises at least one part of the operation terminals and the demand terminal, but excludes the evaluated terminal.

15. The project task assignment method as claimed in claim 14, wherein the ability weight is a weighted combination of multiple sub-ability weights;
wherein when the influence weight corresponding to the evaluated terminal is computed by the processor, the project task assignment method comprises:
computing the weighted average of the sub-ability weights to be the ability weight by the processor.

16. The project task assignment method as claimed in claim 12, wherein the project detail data comprises an influence weight restriction;
wherein the execution terminal database comprises an influence weight of one of the at least one part of the execution terminals;
wherein when the matching scores corresponding to the at least one part of the execution terminals are generated by the processor, the project task assignment method comprises:
executing a numerical comparison between the influence weight and the influence weight restriction, and generating one of the matching scores at least based on a result of the numerical comparison by the processor.

17. A project task assignment method, executed by a project task assignment system; wherein the project task assignment system comprises a storage device and a processor; wherein the processor connects to the storage device, and communicates with at least one demand terminal and multiple execution terminals; wherein the project task assignment method comprises:
building a task assignment database and an execution terminal database in the storage device by the processor; wherein the task assignment database stores multiple candidate project types, and the execution terminal database stores multiple feedback data associated with multiple execution terminals;
receiving a project dispatching signal from the demand terminal, and acquiring an assigned project type and project detail data according to the project dispatching signal by the processor; wherein the assigned project type is one of the candidate project types;
determining an assigned task assignment sequence according to the project dispatching signal, and generating multiple matching scores corresponding to at least one part of the execution terminals by the processor; wherein one of the matching scores represents a matching degree between first data and second data; wherein the first data comprises the feedback data of one of the execution terminals, and the second data comprises the assigned project type and the project detail data;
acquiring multiple operation terminals at least based on the matching scores by the processor; wherein the operation terminals are one part of the execution terminals corresponding to the matching scores;
transmitting at least one project starting signal to at least one of the operation terminals according to the assigned task assignment sequence by the processor; wherein an intermediate product is transferred between two of the operation terminals, and at least one final product is received by at least one of the operation terminals; wherein the at least one project starting signal is associated with the project dispatching signal;
selectively storing the assigned task assignment sequence into the task assignment database as one of the multiple candidate task assignment sequences by the processor; and
receiving a final product score associated with the final product from the demand terminal, generating at least one base score at least associated with the final product score, computing a representative score of one of the candidate task assignment sequences corresponding to the assigned task assignment sequence based on the at least one base score, and storing the representative score into the task assignment database by the processor.

18. The project task assignment method as claimed in claim 17, wherein when the representative score of one of the candidate task assignment sequences corresponding to the assigned task assignment sequence is computed based on the at least one base score by the processor, the project task assignment method comprises:
determining whether the candidate task assignment sequence has an original representative score by the processor;
if no, computing the at least one base score associated with the final product score, and establishing the representative score of the corresponding candidate task assignment sequence by the processor;
if yes, updating the representative score of the corresponding candidate task assignment sequence by weighted calculating according to the at least one base score and the original representative score by the processor.

19. The project task assignment method as claimed in claim 17, wherein when the representative score of one of the candidate task assignment sequences corresponding to the assigned task assignment sequence is computed based on the at least one base score by the processor, the project task assignment method comprises:
receiving multiple scores from the operation terminals and the demand terminal, and generating multiple personal scores associated with the operation terminals based on the scores by the processor;
computing a weighted average score according to the personal scores by the processor; and
computing the base score associated with the final product score according to the final product score and the weighted average score by the processor.

20. A project task assignment method, executed by a project task assignment system; wherein the project task assignment system comprises a storage device and a processor; wherein the processor connects to the storage device, and communicates with at least one demand terminal and multiple execution terminals; wherein the project task assignment method comprises:
building a task assignment database and an execution terminal database in the storage device by the processor; wherein the task assignment database stores multiple candidate project types, the execution terminal database stores multiple feedback data associated with multiple execution terminals, and one of the feedback data is associated with a feedback task assignment sequence;
receiving a project dispatching signal from the demand terminal, and acquiring an assigned project type and project detail data according to the project dispatching signal by the processor; wherein the assigned project type is one of the candidate project types;
determining an assigned task assignment sequence according to the project dispatching signal, and generating multiple matching scores corresponding to at least one part of the execution terminals by the processor; wherein one of the matching scores represents a matching degree between first data and second data; wherein the first data comprises the feedback data of one of the execution terminals, and the second data comprises the assigned project type and the project detail data;
acquiring multiple operation terminals at least based on the matching scores by the processor; wherein the operation terminals are one part of the execution terminals corresponding to the matching scores;
transmitting at least one project starting signal to at least one of the operation terminals according to the assigned task assignment sequence by the processor; wherein an intermediate product is transferred between two of the operation terminals, and at least one final product is received by at least one of the operation terminals; wherein the at least one project starting signal is associated with the project dispatching signal;
selectively storing the assigned task assignment sequence into the task assignment database as one of the multiple candidate task assignment sequences by the processor; and
generating at least one base score associated with the feedback task assignment sequence, computing a representative score of one of the candidate task assignment sequences corresponding to the feedback task assignment sequence based on the at least one base score, and storing the representative score into the task assignment database by the processor.

21. The project task assignment method as claimed in claim 20, wherein when the representative score of one of the candidate task assignment sequences corresponding to the feedback task assignment sequence is computed based on the at least one base score by the processor, the project task assignment method comprises:
determining whether the candidate task assignment sequence has an original representative score by the processor;
if no, establishing the representative score of the corresponding candidate task assignment sequence based on the at least one base score associated with the feedback task assignment sequence by the processor;
if yes, updating the representative score of the corresponding candidate task assignment sequence by weighted calculating according to the at least one base score and the original representative score by the processor.

22. The project task assignment method as claimed in claim 20, wherein when the at least one base score associated with the feedback task assignment sequence is generated by the processor, the project task assignment method comprises:
computing an influence weight corresponding to the execution terminal which is associated with the feedback task assignment sequence by the processor;
wherein the influence weight is a weighted combination of a professional weight and an ability weight;
wherein the at least one base score associated with the feedback task assignment sequence has a positive correlation with the influence weight.
